(19) United States
(12) Patent Application Publication
(10) Pub. No.: US 2009/0182614 A1
(43) Pub. Date: Jul. 16, 2009

(54) System And Method For Serving Advertisements According To Network Traffic

(75) Inventor: Amol Kekre, Fremont, CA (US)

Correspondence Address: Yahoo! Inc., c/o Kenyon & Kenyon LLP, 333 W. San Carlos Street, Suite 600, San Jose, CA, 95110, US

(73) Assignee: YAHOO! INC., Sunnyvale, CA (US)

(21) Appl. No.: 12/013,381

(22) Filed: Jan. 11, 2008

(51) Int. Cl. G06Q 30/00; G06F 15/173

(52) U.S. Cl. 705/10; 709/224; 705/14

(57) ABSTRACT

A system and method may allow an advertiser to sign a conditional contract with an advertising network so that the advertiser's advertisement may be displayed on a web page only when the network traffic thereto exceeds a threshold level. The system may have a network traffic monitoring server which may obtain information about actual network traffic level to the web page, compare the actual network traffic level to the web page with the threshold level, and output an enabling signal when the actual network traffic level exceeds the threshold level. An advertising network server may store the contract between the advertiser and the advertising network, send the threshold level to the network traffic monitoring server, and be configured to display the advertiser's advertisement on the web page only when it receives the enabling signal from the network traffic monitoring server.

### BACKGROUND

1. Field of the Invention

The present invention relates generally to online advertising, and more particularly to a system and method for providing targeted advertisements.

2. Description of Related Art

With the growth of the Internet, online advertising is becoming more and more important for advertisers (buyers of advertising spaces, e.g., Nike™). In one approach, an advertiser may pay an advertising network a certain amount of money for a certain number of impressions. The advertising network may put the advertiser's advertisement(s) on web pages of different publishers (websites selling advertising space, e.g., www.yahoo.com, and www.cnn.com), and display the advertisement when a user (anybody browsing a website) browses the publisher's website. One problem of this approach is that it may not take into account variations in network traffic, and in particular, may not take into account potentially favorable advertising times when network traffic spikes. For example, an advertiser for sporting goods may have a pay per impression contract with an advertising network for displaying an advertisement on one or more sports related web pages. Sports fans, at whom the advertiser wants to target its advertisement(s), may pay more attention to a sports related web page a few days before and after a popular sporting event, e.g., a match between two top-rated NBA teams, and traffic to the sports related web page may surge during that period of time, as shown in FIG. 3A. Major sporting events like the NBA Finals, the World Series, or the Super Bowl cause known network traffic spikes at known times. Advertisers bargain in advance for advertising time for such events, knowing that the number of impressions will be higher in the times surrounding those events. However, network traffic for other events is not so predictable. At the time of signing a contract for a mid-season sporting event, it is hard for the advertiser to predict which event is going to be popular, and how many impressions it should purchase. If the advertiser pays for a low number of impressions, it may miss passionate users since the purchased impressions may run out before the traffic surge.

In another approach, an advertiser may pay a publisher, through an advertising network, a certain amount of money for displaying an advertisement for a certain period of time. But if the traffic to the publisher's web page unexpectedly surges during this period of time, the publisher may make less money than it should be able to.

Therefore, it may be desirable to provide a system and method which may serve an advertisement in response to network traffic, and improve advertising effectiveness.

### BRIEF DESCRIPTION OF THE DRAWING FIGURES

Embodiments of the present invention are described herein with reference to the accompanying drawings, similar reference numbers being used to indicate functionally similar elements.

FIG. 1 illustrates an exemplary environment in which a system of the present invention may be used.

FIG. 2 illustrates a system for serving advertisements in response to network traffic according to one embodiment of the present invention, used in the exemplary environment shown in FIG. 1.

FIG. 3A illustrates an example of fluctuating network traffic to a web page.

FIG. 3B illustrates an example of an enabling signal generated by a network traffic monitoring server in response to network traffic according to one embodiment of the present invention.

FIG. 4 illustrates a flow chart of a method for serving advertisements in response to network traffic according to one embodiment of the present invention.

### DETAILED DESCRIPTION

The present invention provides a system and method which may allow an advertiser to sign a conditional contract with an advertising network so that the advertiser's advertisement may be displayed on a web page only when the network traffic thereto exceeds a threshold level. The system may have a network traffic monitoring server which may obtain information about actual network traffic level to the web page, compare the actual network traffic level to the web page with the threshold level, and output an enabling signal when the actual network traffic level exceeds the threshold level. An advertising network server may store the contract between the advertiser and the advertising network, send the threshold level to the network traffic monitoring server, and be configured to display the advertiser's advertisement on the web page only when it receives the enabling signal from the network traffic monitoring server. An advertiser will not be charged until its advertisement is displayed on the web page. Since users visiting the web site during the traffic surge, or on days close to an important or popular event, are more likely to be the users the advertiser wants to target, the invention may help to improve targeting accuracy and advertising effectiveness. The invention may help advertisers and advertising networks to take advantage of network traffic surges. The present invention may further collect information about a user, and fine tune advertisements to be displayed accordingly. The invention may be carried out by computer-executable instructions, such as program modules. Advantages of the present invention will become apparent from the following detailed description.

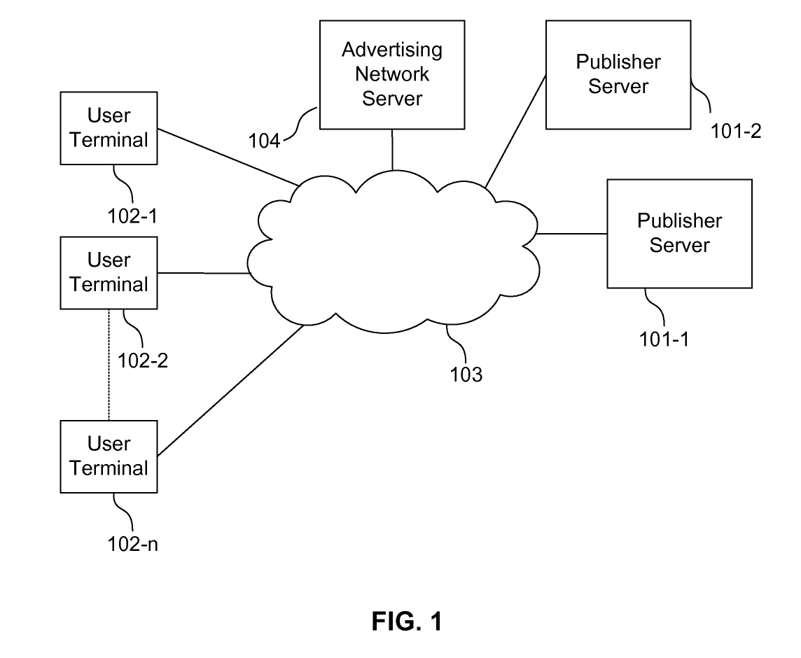

FIG. 1 illustrates an exemplary environment in which a system of the present invention may be used. As shown, publisher servers 101-1 and 101-2 may communicate over a network 103 with a number of user terminals 102-1, 102-2, . . . 102-n. A publisher server 101 may be a computer system and may control the operation of a website or a blog. The user terminals 102 may be personal computers, handheld or laptop devices, microprocessor-based systems, set top boxes, or other programmable consumer electronics. Each user terminal may have a browser application configured to receive and display web pages, which may include text, graphics, multimedia, etc. The web pages may be based on, e.g., HyperText Markup Language (HTML) or extensible markup language (XML). One or more advertisements may be displayed on a web page. Network connectivity may be wired or wireless, using one or more communications protocols, as will be known to those of ordinary skill in the art.

An advertising network server 104 may be coupled to the network 103 to send advertisements to publisher servers according to contracts between publishers, advertisers and the advertising network. As mentioned above, the contracts may be, e.g., a pay per impression contract or a fixed-term contract.

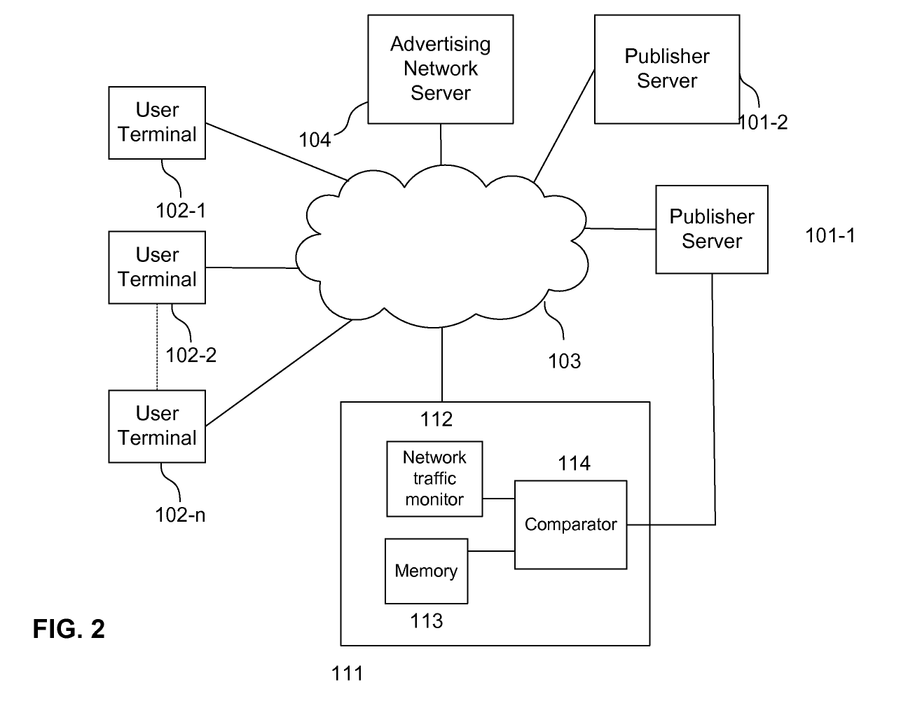

FIG. 2 illustrates a system according to one embodiment of the present invention, used in the exemplary environment shown in FIG. 1. As shown, a network traffic monitoring server 111 may be coupled to the network 103 and communicate with at least one advertising network server 104 and at least one publisher server 101. The network traffic monitoring server 111 may have a network traffic monitor 112, a memory 113 and a comparator 114.

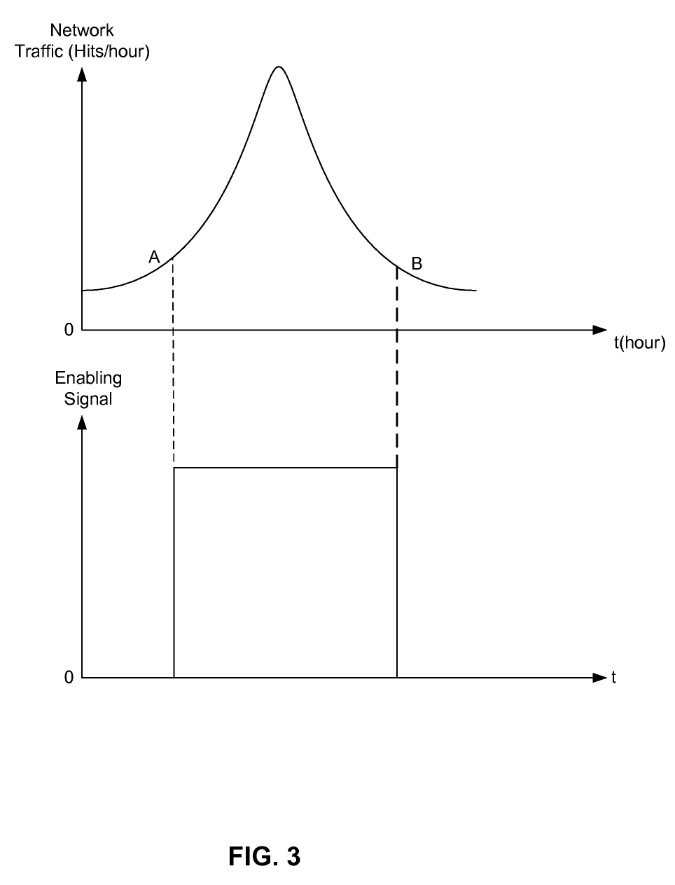

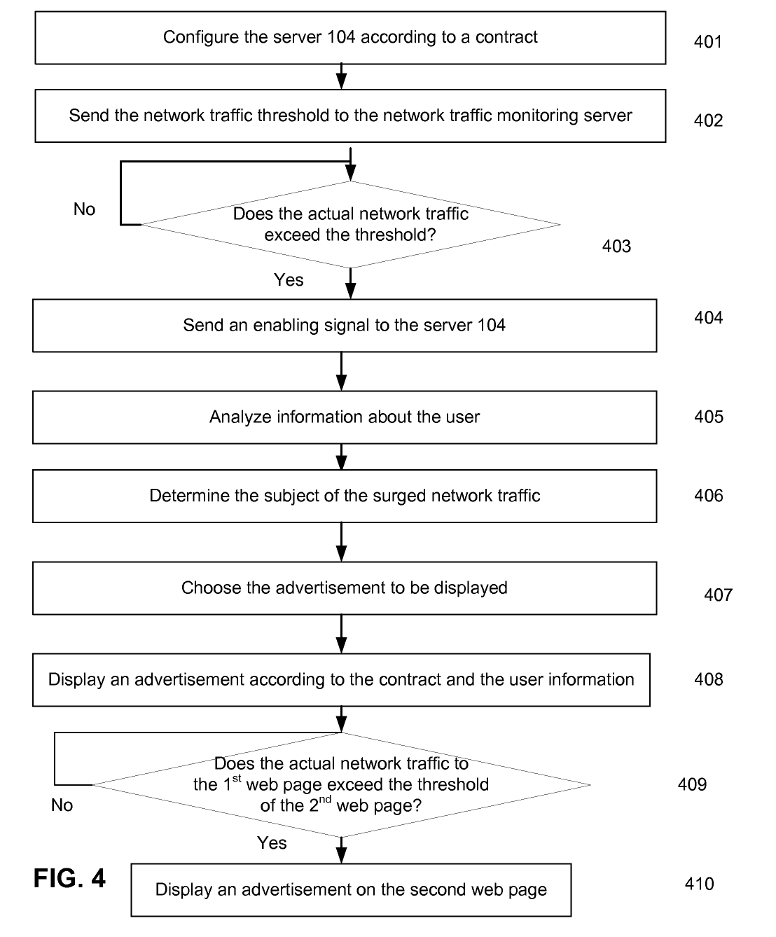

The network traffic monitor 112 may be used to examine traffic to one or more web pages to obtain real time traffic level data. The network traffic monitor 112 may be implemented in software, in hardware, or in a combination of the two. In one embodiment, the network traffic monitor 112 may count the number of connections to a web page during a certain period of time, e.g., one minute, as shown in FIG. 3A. In another embodiment, the network traffic monitor 112 may send a probe to a publisher server to check network traffic volume by, e.g., the length of the request queue at the publisher server or the response time of the publisher server. In general, the higher the traffic volume, the longer the request queue, and the longer the response time. In a further embodiment, the network traffic monitor 112 may be a Microsoft Proxy or ISA (Internet Security and Acceleration) server, watching the actual traffic to one or more web pages in real time. Although the network traffic monitor 112 is shown in FIG. 2 as a part of the network traffic monitoring server 111, it should be understood that it may be installed in a publisher server 101, or on the path between the server 111 and a publisher server 101.

The memory 113 may receive a threshold traffic level for each web page from the advertising network server 104. The threshold traffic level may be set forth in a contract between an advertiser and the advertising network, and indicate that the advertiser is willing to pay to display its advertisement on a web page only when the actual network traffic to the web page exceeds the threshold traffic level. The threshold traffic level may be, for example, 100 k visits per hour, as shown in FIG. 3A.

The comparator 114 may compare the actual level of network traffic to a web page with the threshold traffic level of that web page. When the actual level of network traffic exceeds the threshold, e.g., at point A in FIG. 3A, the comparator may send an enabling signal to the advertising network server 104, so that the server 104 may begin to display the advertiser's advertisement on the web page. In one embodiment, the comparator may send the enabling signal periodically to keep the advertising network server 104 in an enabled state for this web page. This period may be predetermined according to a rate of change of traffic patterns. For example it may be 1 minute. In one embodiment, the enabling signal may be sampled. When the actual level of network traffic falls below the threshold, e.g., at point B in FIG. 3A, the comparator 114 may stop outputting the enabling signal, and the server 104 may stop displaying the advertiser's advertisement on the web page. Between time points A and B, when the enabling signal is being output, then, the advertisement will be displayed, and the number of impressions monitored to determine how much the advertising is costing the advertiser.

In one embodiment, the network traffic monitoring server 111 may have one comparator working in a time division manner by assigning a time slot to each web page. During the time slot for a web page, e.g., sports.yahoo.com, the comparator may receive the threshold traffic level for this web page from the memory 113, receive the actual traffic level from the network traffic monitor 112, and compare the two signals. In another embodiment, the network traffic monitoring server 111 may have a comparator for each web page.

In the embodiment shown in FIG. 2, in addition to the above mentioned pay-per-impression contracts and fixed-term contracts, the advertising network server 104 may also store a conditional contract between an advertiser (Nike™), an advertising network and a web page (sports.yahoo.com), e.g., a Nike™ advertisement will be displayed on the sports.yahoo.com web page only when the traffic to the web page exceeds a certain number of visits, e.g., 100 k visits per hour, or when the traffic to the web page exceeds 150% of the average network traffic level. The advertising network server 104 may send the threshold traffic level, i.e., 100 k visits per hour, to the network traffic monitoring server 111. The advertising network server 104 may also display the advertiser's advertisement on the web page when receiving an enabling signal from the network traffic monitoring server 111, indicating that the network traffic to the web page exceeds the threshold traffic level of that web page.

The advertising network server 104 may access information about a user to further improve targeting accuracy. In one embodiment, the advertising network server 104 may determine the user's geographic location by, e.g., cookies or the user's IP address. With the geographic location information, the advertising network server 104 may determine advertisements for offers or services available in the user's area. In another embodiment, the advertising network server 104 may obtain the user's recent browsing history and/or demographic information to fine tune advertisements to the user.

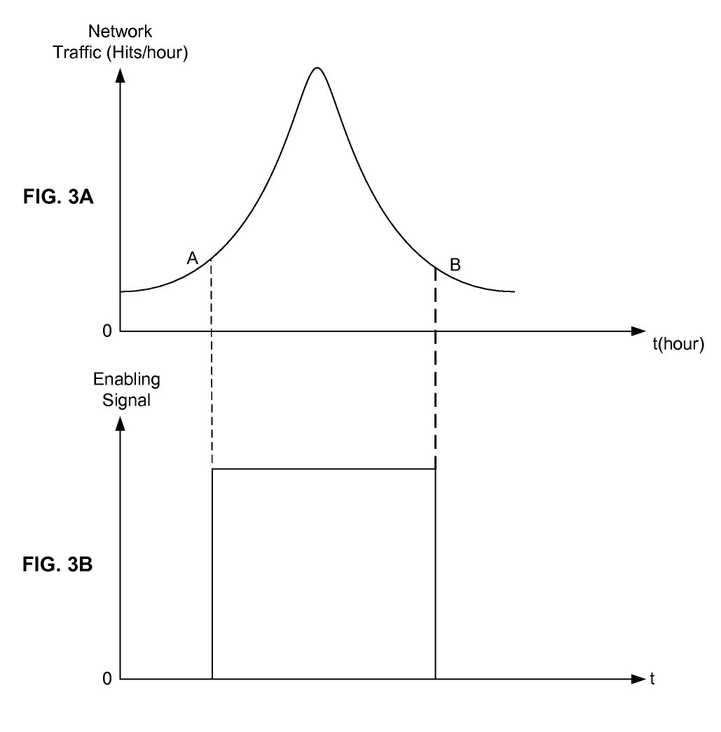

Each of the servers 104 and 111 may be a computer system, which may include one or more of a screen, an input device, a processing unit, a system memory, and a system bus coupling various components in the computer system. The servers 104 and 111 may control processes related to serving advertisements, including but not limited to those described below with reference to FIG. 4. Although 104 and 111 are shown as separate servers in FIG. 2, it should be understood that their functions may be carried out by one server.

In one embodiment, the network traffic monitor 112 may monitor traffic to one web page, e.g., sports.yahoo.com. In another embodiment, the network traffic monitor 112 may monitor traffic to a category of web pages, and a surge of traffic to any web page in this category may be regarded as a surge of traffic to each web page in the category. For example, web pages sport.yahoo.com and sports.groups.yahoo.com belong to the category “sports,” and when a surge of traffic to the web page sports.yahoo.com is detected, the server 104 may be enabled to display advertisements on the web page sports.groups.yahoo.com as well.

FIG. 4 illustrates a flow chart of a method for serving advertisements in response to network traffic according to one embodiment of the present invention.

At 401, the advertising network server 104 may be configured according to a contract between an advertiser (e.g., Nike™) and an advertising network, so that a Nike™ advertisement may be displayed on a web page (e.g., sports.yahoo.com) when the network traffic to that web page exceeds a certain threshold, e.g. 100 k visits per hour.

At 402, the server 104 may send the threshold traffic level of the web page sports.yahoo.com to the network traffic monitoring server 111.

At 403, the network traffic monitoring server 111, or more specifically the network traffic monitor 112, may begin to monitor network traffic to the web page sports.yahoo.com, and the comparator 114 may compare the actual network traffic with the web page's threshold traffic level.

At 404, when the actual network traffic to the web page sports.yahoo.com exceeds its threshold traffic level, the network traffic monitoring server 111, or more specifically the comparator 114, may send an enabling signal to the advertising network server 104.

At 405, the advertising network server 104 may access information about the user, and find out that the user is a female.

At 406, the advertising network server 104 may find out that the majority of the network traffic is related to obtaining information about the particular sporting event, and determine that the subject of the surged network traffic is about the particular sport.

At 407, the advertising network server 104 may consider the subject of the surged network traffic and user information, and choose an advertisement for clothing appropriate to the sporting event, for example.

At 408, the server 104 may have the advertisement displayed on the web page sports.yahoo.com.

At 409, the comparator 114 may compare the actual network traffic to the web page sports.yahoo.com to the threshold traffic level of another web page in the advertising category “sports”, e.g., the web page sports.groups.yahoo.com.

At 410, if the actual network traffic to the web page sports.yahoo.com exceeds the threshold traffic level of sports.groups.yahoo.com, the advertising network server 104 may choose and display an advertisement on the web page sports.groups.yahoo.com.

The invention may be used to catch network traffic surges caused by other events, e.g., political events, entertainment events, and monetary policy changes.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

What is claimed is:

1. A method for serving an advertisement, comprising:
receiving a threshold network traffic level of a first web page;
obtaining an actual network traffic level to the first web page;
comparing the threshold network traffic level of the first web page and the actual network traffic level to the first web page; and
displaying an advertiser's advertisement on the web page when the actual network traffic level exceeds the threshold network traffic level.

2. The method of claim 1, further comprising selecting one of the advertiser's advertisements for displaying.

3. The method of claim 2, further comprising considering information about a user when selecting the advertisement to be displayed.

4. The method of claim 3, wherein the information about the user comprises a geographic location of the user.

5. The method of claim 3, wherein the information about the user comprises demographical information about the user.

6. The method of claim 2, further comprising considering a subject of the network traffic to the first web page when selecting the advertisement to be displayed.

7. The method of claim 1, wherein the obtaining further comprising sending a probe to check network traffic volume.

8. The method of claim 1, wherein the obtaining further comprising counting a number of hits on the web page.

9. The method of claim 1, further comprising: comparing the actual network traffic level to the first web page belonging to a first advertising category with a threshold network traffic level of a second web page belonging to the advertising category.

10. The method of claim 1, further comprising comparing the actual network traffic level to the first web page belonging to a first advertising category with a threshold network traffic level of a plurality of web pages belonging to the first advertising category.

11. A computer program product comprising a computer-readable medium having instructions for performing the method of claim 1.

12. A computer program product comprising a computer-readable medium having instructions for performing the method of claim 2.

13. A computer program product comprising a computer-readable medium having instructions for performing the method of claim 3.

14. A computer program product comprising a computer-readable medium having instructions for performing the method of claim 6.

15. A computer program product comprising a computer-readable medium having instructions for performing the method of claim 7.

16. A computer program product comprising a computer-readable medium having instructions for performing the method of claim 8.

17. A computer program product comprising a computer-readable medium having instructions for performing the method of claim 9.

18. A system for serving an advertisement, comprising:
an advertising server configured according to a contract between an advertiser and an advertising network; and
a network traffic monitoring server for receiving from the advertising server a threshold network traffic level of a web page, monitoring actual network traffic to the web page, and outputting an enabling signal to the advertising server when the actual network traffic exceeds the threshold level, so that the advertising server can have the advertiser's advertisement displayed on the web page.

19. The system of claim 18, wherein the advertising server further selects an advertisement to be displayed based on information about a visitor to the web page.

20. The system of claim 18, wherein the advertising server further selects an advertisement to be displayed based on a subject of the network traffic.

21. A network traffic monitoring server, comprising:
a memory for storing a threshold network traffic level of a first web page;
a network traffic monitor for obtaining actual network traffic level to the first web page; and
a comparator for comparing the actual network traffic level to the first web page and the threshold network traffic level of the first web page, and outputting an enabling signal when the actual network traffic level exceeds the threshold level, so as to enable an advertisement to be displayed on the first web page.

22. The server of claim 21, wherein the network traffic monitor counts a number of hits on the at least one web page.

23. The sever of claim 21, wherein the network traffic monitor sends a probe to obtain the actual network traffic level to the at least one web page.

24. The server of claim 21, wherein the comparator further compares the actual network traffic level to the first web page belonging to a first advertising category and the threshold network traffic level of a plurality of web pages belonging to the first advertising category.

25. The server of claim 21, wherein the comparator further outputs an enabling signal when the actual network traffic level to the first web page exceeds the threshold level of the second web page, so as to enable an advertisement to be displayed on the second web page.
